(19) United States
(12) Patent Application Publication
(10) Pub. No.: US 2022/0164827 A1
(43) Pub. Date: May 26, 2022

(54) ADVERTISEMENT DELIVERY SYSTEM, INFORMATION PROCESSING APPARATUS, AND INFORMATION PROCESSING METHOD

(71) Applicant: SONY GROUP CORPORATION, TOKYO (JP)

(72) Inventors: TAKAYOSHI HIRAI, TOKYO (JP); YUSUKE NAKAMURA, TOKYO (JP); KAZUHIRO OOI, TOKYO (JP)

(21) Appl. No.: 17/437,066

(22) PCT Filed: Mar. 13, 2020
(86) PCT No.: PCT/JP2020/011264

§ 371 Date: Sep. 8, 2021

(30) Foreign Application Priority Data
Mar. 19, 2019 (JP) 2019-051595

(51) Int. Cl. G06Q 30/02

(52) U.S. Cl. CPC G06Q 30/0255; G06Q 30/0272

(57) ABSTRACT

Provided is an advertisement delivery system including an acquisition unit configured to acquire location information regarding a first user, a delivery unit configured to enable, on the basis of location information regarding an advertisement providing shop that has been registered and the location information regarding the first user, delivery of predetermined content with advertisement information from the advertisement providing shop, and a setting unit configured to set an experienceable period for the first user that indicates a period in which the first user is allowed to experience the predetermined content, in which the setting unit updates the experienceable period for the first user on the basis of the location information regarding the advertisement providing shop and the location information regarding the first user during the experienceable period for the first user.

### TECHNICAL FIELD

The present disclosure relates to an advertisement delivery system, an information processing apparatus, and an information processing method.

### BACKGROUND ART

In recent years, an increasing number of users have been using services that provide entertainment content, such as music and comics, to users for free or at a low price by adding advertisements to the content. Various technologies have been known as technologies for providing content to users. For example, there is disclosed a technology for acquiring operation information regarding the user's operation of opening content delivered to the user's terminal apparatus in a predetermined area, and determining, on the basis of the acquired operation information, a content delivery mode in the predetermined area (for example, see PTL 1).

### CITATION LIST

### Patent Literature

[PTL 1]

Japanese Patent Laid-open No. 2018-156460

### SUMMARY

### Technical Problem

However, it is desired that a technology for increasing the number of users who purchase products or services sold by advertisement providers be provided.

### Solution to Problem

According to the present disclosure, there is provided an advertisement delivery system including an acquisition unit configured to acquire location information regarding a first user, a delivery unit configured to enable, on the basis of location information regarding an advertisement providing shop that has been registered and the location information regarding the first user, delivery of predetermined content with advertisement information from the advertisement providing shop, and a setting unit configured to set an experienceable period for the first user that indicates a period in which the first user is allowed to experience the predetermined content, in which the setting unit updates the experienceable period for the first user on the basis of the location information regarding the advertisement providing shop and the location information regarding the first user during the experienceable period for the first user.

According to the present disclosure, there is provided an information processing apparatus including an acquisition unit configured to acquire location information regarding a first user, a delivery unit configured to enable, on the basis of location information regarding an advertisement providing shop that has been registered and the location information regarding the first user, delivery of predetermined content with advertisement information from the advertisement providing shop, and a setting unit configured to set an experienceable period for the first user that indicates a period in which the first user is allowed to experience the predetermined content, in which the setting unit updates the experienceable period for the first user on the basis of the location information regarding the advertisement providing shop and the location information regarding the first user during the experienceable period for the first user.

According to the present disclosure, there is provided an information processing method including acquiring, by a processor, location information regarding a first user, enabling, by the processor, on the basis of location information regarding an advertisement providing shop that has been registered and the location information regarding the first user, delivery of predetermined content with advertisement information from the advertisement providing shop, setting, by the processor, an experienceable period for the first user that indicates a period in which the first user is allowed to experience the predetermined content, and updating, by the processor, the experienceable period for the first user on the basis of the location information regarding the advertisement providing shop and the location information regarding the first user during the experienceable period for the first user.

### BRIEF DESCRIPTION OF DRAWINGS

FIG. 1 is a diagram illustrating a configuration example of an advertisement delivery system according to an embodiment of the present disclosure.

FIG. 2 is a diagram illustrating a functional configuration example of a server according to the embodiment of the present disclosure.

FIG. 3 is a diagram illustrating the overall function of the advertisement delivery system according to the embodiment of the present disclosure.

FIG. 4 is a flowchart illustrating an exemplary function that is achieved by a server application.

FIG. 5 is a diagram illustrating an exemplary screen that is used in a creator step.

FIG. 6 is a diagram illustrating the flow of the creator step.

FIG. 7 is a diagram illustrating an exemplary advertisement creation screen.

FIG. 8 is a diagram illustrating delivery information.

FIG. 9 is a diagram illustrating the flow of a user step.

FIG. 10 is a diagram illustrating exemplary screens of a terminal application.

FIG. 11 is a diagram illustrating exemplary display of delivery information.

FIG. 12 is a diagram illustrating exemplary display of an advertisement delivery shop and delivery content.

FIG. 13 is a diagram illustrating content examples that are recommended to respective shop terminals.

FIG. 14 is a diagram illustrating an exemplary share start screen.

FIG. 15 is a diagram illustrating the flow of a share function.

FIG. 16 is a diagram illustrating an exemplary content sharing process.

FIG. 17 is a diagram illustrating an exemplary charging system.

FIG. 18 is a diagram illustrating exemplary localized content delivery.

FIG. 19 is a diagram illustrating an exemplary content review input screen.

FIG. 20 is a diagram illustrating the flow of review sharing.

FIG. 21 is a block diagram illustrating a hardware configuration example of the server according to the embodiment of the present disclosure.

### DESCRIPTION OF EMBODIMENT

A preferred embodiment of the present disclosure is described in detail below with reference to the accompanying drawings. Note that, in the present specification and the drawings, components having substantially the same functional configuration are denoted by the same reference symbols to omit redundant description.

Further, in the present specification and the drawings, a plurality of components having substantially the same or similar functional configurations is denoted by the same reference symbols suffixed with different numbers in some cases to distinguish the components from each other. However, in a case where there is no particular need to distinguish a plurality of components having substantially the same or similar functional configurations from each other, the components are denoted by the same reference symbols. Further, similar components of different embodiments are denoted by the same reference symbols suffixed with different letters in some cases to distinguish the components from each other. However, in a case where there is no particular need to distinguish similar components, the components are denoted by the same reference symbols.

Note that, the following items are described in order.

0. Outline

1. Details of Embodiment
1.1. Configuration Example of Advertisement Delivery System
1.2. Functional Configuration Example of Server
1.3. Overall Function of System
1.4. Content
1.5. Share Function
1.6. Application to Spotify
1.7. Popularity Analysis
1.8. Charging System
1.9. Localized Delivery
1.10. Review Interaction Function
1.11. Analysis Function
1.12. Share Point

2. Hardware Configuration Example

3. Conclusion

### <0. Outline>

In recent years, an increasing number of users have been using services that provide entertainment content, such as music and comics, to users for free or at a low price by adding advertisements to the content. Various technologies have been known as technologies for providing content to users. Thus, in an embodiment of the present disclosure, a technology for increasing the number of users who purchase products or services sold by advertisement providers is mainly described.

Specifically, in the embodiment of the present disclosure, there is proposed a technology for updating, during an experienceable period in which a user can experience content, the experienceable period on the basis of location information regarding an advertisement providing shop and location information regarding the user. With this configuration, it is possible to prompt the user to take action to update the experienceable period. For example, when a condition that the user approaches the advertisement providing shop is set as a condition for updating the experienceable period, the possibility that the user purchases products or services at the advertisement providing shop increases. Alternatively, when a condition that the user makes charging setting is set as a condition for updating the experienceable period, the possibility that the user pays for the advertisement providing shop increases.

Further, in a case where, as a plan more expensive than the plan in which the user receives advertisements when experiencing the content (with advertisement plan), a plan in which the user can experience the content with no advertisement (premium plan) is prepared, it is possible to prompt the user to change the plan from the with advertisement plan to the premium plan.

In the above, the outline of the embodiment of the present disclosure has been described.

### <1. Details of Embodiment>

### [1.1. Configuration Example of Advertisement Delivery System]

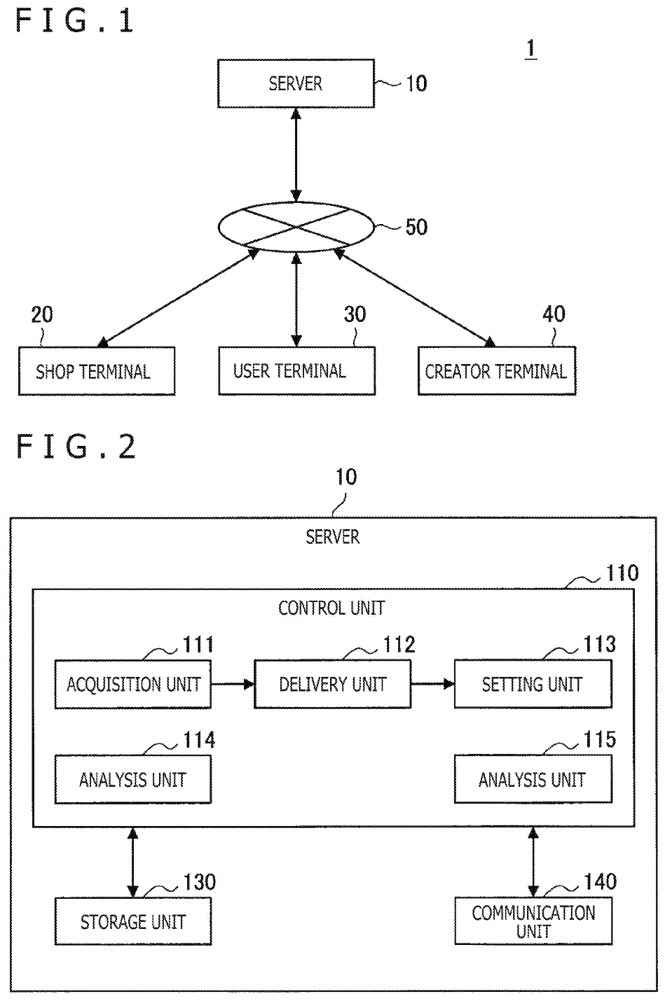

Subsequently, with reference to the drawings, a configuration example of an advertisement delivery system according to the embodiment of the present disclosure is described. FIG. 1 is a diagram illustrating the configuration example of the advertisement delivery system according to the embodiment of the present disclosure. As illustrated in FIG. 1, an advertisement delivery system 1 according to the embodiment of the present disclosure includes a server 10, a shop terminal 20, a user terminal 30, a creator terminal 40, and a network 50. The server 10, the shop terminal 20, the user terminal 30, and the creator terminal 40 are communicable with each other via the network 50.

The shop terminal 20 includes, for example, a computer. Here, a case where the shop terminal 20 is a smartphone is mainly assumed. However, the shop terminal 20 may be a terminal other than the smartphone. For example, the shop terminal 20 may be a PC (Personal Computer), a tablet terminal, a cell phone, or another type of electronic device. For example, the shop terminal 20 is used by a clerk. Further, the shop terminal 20 can execute an advertisement setting-use application (hereinafter also simply referred to as “advertisement setting application”) to achieve the advertisement setting function of the shop terminal 20. The advertisement setting function is described later in detail.

The user terminal 30 includes, for example, a computer. Here, a case where the user terminal 30 is a smartphone is mainly assumed. However, the user terminal 30 may be a terminal other than the smartphone. For example, the user terminal 30 may be a PC, a tablet terminal, a cell phone, or another type of electronic device. For example, the user terminal 30 is used by a user. Further, the user terminal 30 can execute a user terminal-use application (hereinafter also simply referred to as “terminal application”) to achieve various functions of the user terminal 30.

Note that, in the example illustrated in FIG. 1, for the sake of simplicity of FIG. 1, the case where the advertisement delivery system 1 includes the single user terminal 30 is illustrated. However, in reality, the advertisement delivery system 1 may include a plurality of the user terminals 30. In this case, the plurality of user terminals 30 can be used by respective individual users. Note that, in a case where content is shared by users, it is mainly assumed that the content is shared between friends. Thus, in the following description, as a matter of convenience, content sharing destinations with respect to a content sharing source are called “friend” in some cases. The content sharing is described later in detail.

The creator terminal 40 includes, for example, a computer. Here, a case where the creator terminal 40 is a smartphone is mainly assumed. However, the creator terminal 40 may be a terminal other than the smartphone. For example, the creator terminal 40 may be a PC, a tablet terminal, a cell phone, or another type of electronic device. For example, the creator terminal 40 is used by a creator. Further, the creator terminal 40 can execute a content registration-use application (hereinafter also simply referred to as “registration application”) to achieve the content registration function of the user terminal 30. The content registration function is described later in detail.

Note that, the creator is a person who provides content. More specifically, the creator may be a person who has actually created content (for example, music creator or comic artist), or may be an agent company such as a music agency. Further, the content is of any type. For example, the content may include still images, video, text data, audio data (music content or the like), or a combination of still images and text data (comics or the like). In the following, a case where the content is entertainment content such as music content or comics is mainly assumed.

The server 10 includes, for example, a computer and functions as an example of an information processing apparatus. The server 10 can execute a server application to achieve various functions of the server 10. The server 10 receives a request transmitted from the shop terminal 20 via the network 50, and sends back a response to the request to the shop terminal 20 via the network 50. In a similar manner, the server 10 receives a request transmitted from the user terminal 30 via the network 50, and sends back a response to the request to the user terminal 30 via the network 50. Further, the server 10 receives a request transmitted from the creator terminal 40 via the network 50, and sends back a response to the request to the creator terminal 40 via the network 50.

In the above, the configuration example of the advertisement delivery system 1 according to the embodiment of the present disclosure has been described.

### [1.2. Functional Configuration Example of Server]

Subsequently, a functional configuration example of the server 10 according to the embodiment of the present disclosure is described. FIG. 2 is a diagram illustrating the functional configuration example of the server 10 according to the embodiment of the present disclosure. As illustrated in FIG. 2, the server 10 includes a control unit 110, a storage unit 130, and a communication unit 140.

The control unit 110 controls each unit of the server 10. The control unit 110 may include, for example, one or a plurality of CPUs (Central Processing Units). In the case where the control unit 110 includes a processing apparatus such as a CPU, this processing apparatus may include an electronic circuit. The control unit 110 can be achieved by this processing apparatus executing a program. The control unit 110 includes an acquisition unit 111, a delivery unit 112, a setting unit 113, an analysis unit 114, and an analysis unit 115. The details of these blocks are described later.

The storage unit 130 is a recording medium that includes a memory and stores programs that are executed by the control unit 110 and data necessary for program execution. Further, the storage unit 130 temporarily stores data for calculation by the control unit 110. The storage unit 130 includes a magnetic storage unit device, a semiconductor storage device, an optical storage device, a magneto-optical storage device, or the like.

The communication unit 140 includes a communication circuit and has a function of communicating, via the network 50, with the terminals (shop terminal 20, user terminal 30, and creator terminal 40) connected to the network 50.

In the above, the functional configuration example of the server 10 according to the embodiment of the present disclosure has been described.

### [1.3. Overall Function of System]

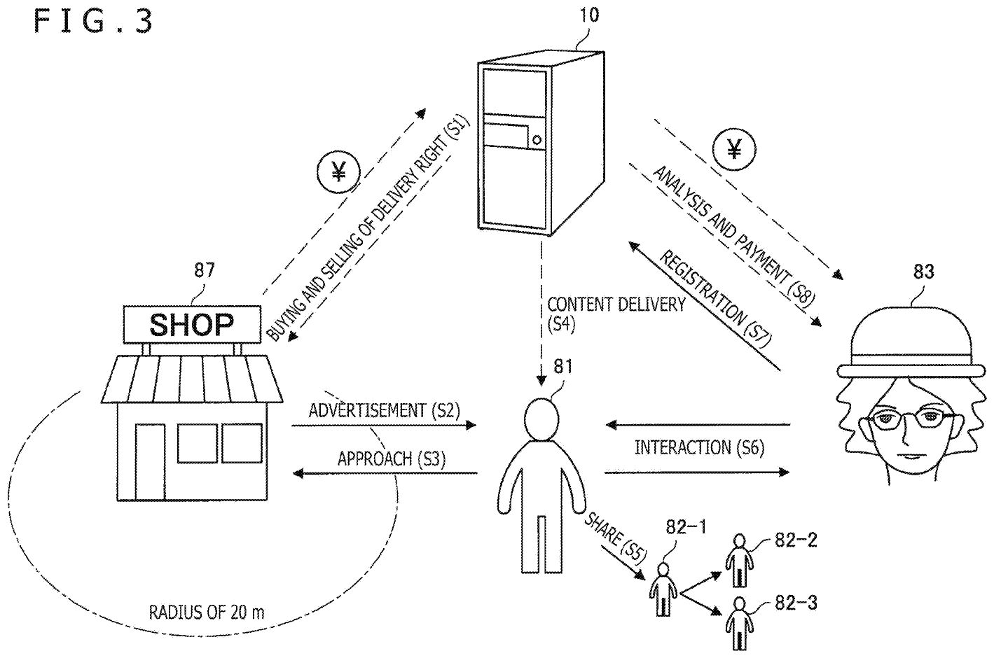

Subsequently, the overall function of the advertisement delivery system 1 according to the embodiment of the present disclosure is described. FIG. 3 is a diagram illustrating the overall function of the advertisement delivery system 1 according to the embodiment of the present disclosure. With reference to FIG. 3, there are illustrated, in addition to the server 10 described above, as things related to the advertisement delivery system 1, a shop 87, a user 81, a creator 83, a friend 82-1 with whom the user 81 shares content, and friends 82-2 and 82-3 with whom the friend 82-1 shares the content.

The advertisement delivery system 1 is a system for delivering content with advertisements. The creator 83 creates content and registers the created content to the server 10 (S7). The shop 87 is an advertisement providing shop that provides advertisements and can obtain the right to deliver advertisements by purchasing the right to deliver advertisements (S1). Specifically, when the right to deliver advertisements is purchased, the content and an advertisement are linked to each other. The advertisement delivery leads to the promotion of the shop (S2).

For example, the user 81 can acquire the right to experience the content when entering the area within a predetermined distance from the shop 87 (for example, within a 20 m radius of the shop 87) (S3). Then, the user 81 who has acquired the right to experience the content can receive the content delivered from the server 10 (S4). The user 81 can experience the content using the user terminal 30 on which the terminal application has been installed. At this time, since the advertisement is linked to the content, the user 81 views the advertisement together with the content.

The content and the advertisement can be shared by the user 81 with the friend 82-1 (S5). Further, the content and the advertisement can be shared by the friend 82-1 with the friends 82-2 and 82-3. After experiencing the content, the user 81 and the friends 82-1 to 82-3 can register content reviews to the server 1-. The creator 83 can view the reviews registered to the server 10. In this way, the advertisement delivery system 1 allows the user 81, the friends 82-1 to 82-3, and the creator 83 to interact with each other (S6).

Moreover, the server 10 can analyze how the content has been delivered and shared. Thus, from the server 10 to the creator 83, the result of analysis in the server 10 and a payment for content creation are given (S8). The details of these functions are described later in due order.

According to the embodiment of the present disclosure, there is provided the advertisement delivery system including:

the acquisition unit 111 configured to acquire location information regarding the user 81 (first user);

the delivery unit 112 configured to enable, on the basis of location information regarding the shop 87 (advertisement providing shop) that has been registered and location information regarding the user 81, delivery of predetermined content with advertisement information from the shop 87 (give the user 81 the right to use the content); and

the setting unit 113 configured to set an experienceable period for the user 81 that indicates a period in which the user 81 is allowed to experience the predetermined content,

in which the setting unit 113 updates the experienceable period for the user 81 on the basis of the location information regarding the shop 87 and the location information regarding the user 81 during the experienceable period for the user 81. These functions are achieved by the server application.

Here, the experienceable period setting may include setting the end of the experienceable period (for example, last day). For example, the end of the experienceable period may be a time point that comes after a predetermined period from the date and time at which the content has been transmitted for the first time. The user 81 can experience the content by downloading the content from the server 10 (or reproducing the streaming content) from the date and time at which the content has been transmitted for the first time to the end of the experienceable period. The experienceable period updating may include updating the end of the experienceable period (for example, last day). For example, the end of the experienceable period may be updated to extend the end of the experienceable period by a predetermined period.

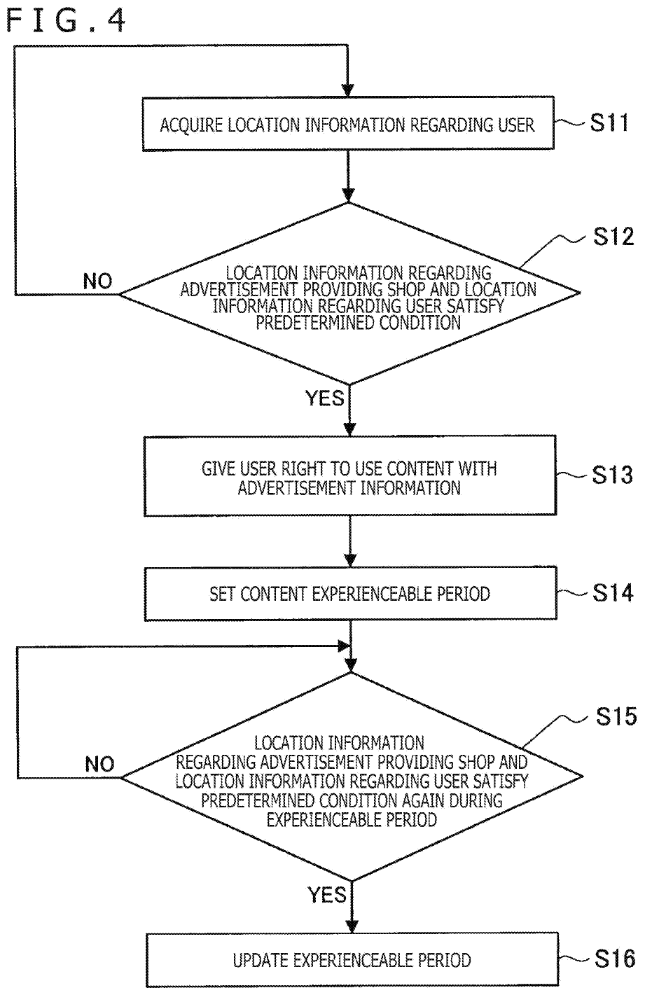

FIG. 4 is a flowchart illustrating an exemplary function that is achieved by the server application. First, when the location of the user terminal 30 is detected by the user terminal 30, the location information regarding the user terminal 30 is acquired by the acquisition unit 111 of the server 10 as location information regarding the user 81 (S11). Meanwhile, location information regarding the shop 87 is stored in the storage unit 130 in advance, and the location information regarding the shop 87 is also acquired by the acquisition unit 111.

The delivery unit 112 enables, on the basis of the location information regarding the shop 87 and the location information regarding the user 81, the delivery of content with advertisement information from the shop 87. Specifically, the delivery unit 112 gives, in a case where the location information regarding the advertisement providing shop (shop 87) and the location information regarding the user 81 satisfy a predetermined condition (first condition) (“YES” in S12), the user 81 the right to use the content with the advertisement information (S13). The right to use content can correspond to the right to experience the content. Meanwhile, the operation transitions to S11 in a case where the location information regarding the advertisement providing shop (shop 87) and the location information regarding the user 81 do not satisfy the predetermined condition (first condition) (“NO” in S12).

The setting unit 113 sets an experienceable period for the user 81 that indicates a period in which the user 81 can experience the content (S14). Then, the setting unit 113 updates the experienceable period for the user 81 on the basis of the location information regarding the shop 87 and the location information regarding the user 81 during the experienceable period for the user 81. Specifically, the setting unit 113 updates, in a case where the location information regarding the advertisement providing shop (shop 87) and the location information regarding the user 81 satisfy a predetermined condition (second condition) again during the experienceable period for the user 81 (“YES” in S15), the experienceable period for the user 81 (S16). Meanwhile, the operation transitions to S15 in a case where the location information regarding the advertisement providing shop (shop 87) and the location information regarding the user 81 do not satisfy the predetermined condition (second condition) during the experienceable period for the user 81 (“NO” in S15).

The “predetermined condition” in S12 may include a condition that a distance between the shop 87 and the user 81 is equal to or shorter than a first distance. Further, the “predetermined condition” in S15 may include a condition that the distance between the shop 87 and the user 81 is equal to or shorter than a second distance. In the embodiment of the present disclosure, the case where the “predetermined condition” in S12 and the “predetermined condition” in S15 are each the condition that the distance between the shop 87 and the user 81 is equal to or shorter than the predetermined distance (20 m in the example illustrated in FIG. 3) is assumed. However, the “predetermined condition” in S12 and the “predetermined condition” in S15 may be different conditions.

The details are described below. The step is divided into four stages: a creator step, a shop step, a server step, and a user step.

### <Creator Step>

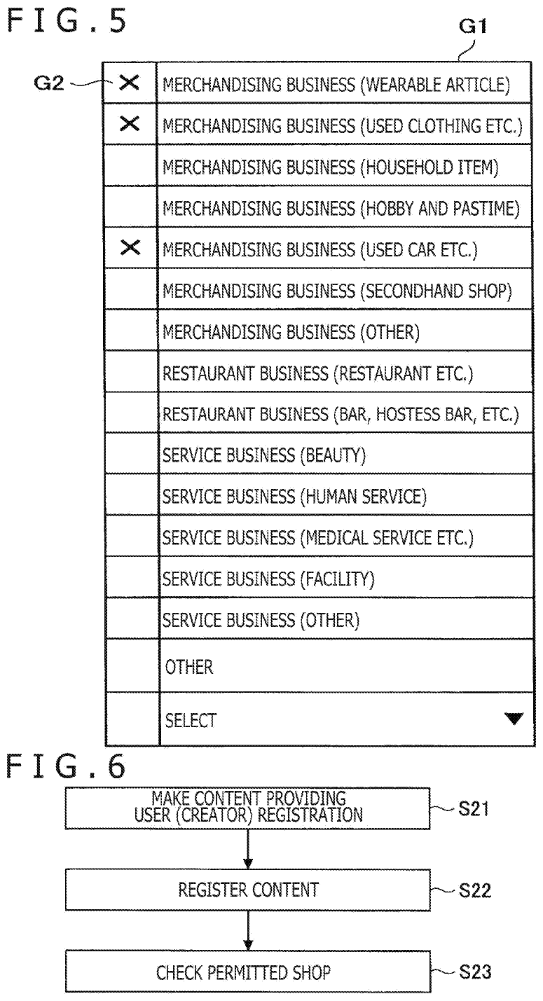

FIG. 5 is a diagram illustrating an exemplary screen that is used in the creator step. FIG. 6 is a diagram illustrating the flow of the creator step. First, the creator 83 installs the registration application on the creator terminal 40. Then, when launching the registration application for the first time, the creator 83 inputs the name, address, bank account (or credit card number), affiliation, login ID, password, and email address to the registration application, to thereby make a content providing user (creator) registration (S21). Next, the creator 83 registers content (S22). There is a plurality of content registration methods. Examples of content registration include content upload registration, content citation registration, and agency batch registration.

When the creator 83 logs in using the set login ID and password, a content registration method selection screen is displayed by the creator terminal 40. Then, the creator 83 selects any one of the content upload registration, content citation registration, and agency batch registration described above.

In a case where the creator 83 selects the content upload registration, a content upload screen is displayed by the creator terminal 40. The creator 83 performs the procedure of uploading the content stored in the creator terminal 40 or in a predetermined folder on the Internet. The creator terminal 40 displays, after the content has been uploaded, a selection screen for the uploaded content: “advertisement information from what type of shop is permitted to be linked and advertisement information from what type of shop is permitted to be delivered” (FIG. 5).

For example, the creator terminal 40 displays a list G1 and checkboxes G2 as illustrated in FIG. 5. With this, the creator 83 checks permitted shops (S23). Specifically, the creator terminal 40 allows the creator 83 to mark × (delivery prohibition) in the checkboxes G2. The registration application transmits, to the server 10, the check status (which type of shop has been checked) in the list G1. In the server 10, shop types are associated with a plurality of pieces of advertisement information, respectively. Thus, the delivery unit 112 selects advertisement information on the basis of the check status and the shop types associated with the plurality of pieces of advertisement information, respectively.

More specifically, the delivery unit 112 selects advertisement information associated with a shop type identical to a shop type selected by the creator 83 of the content. The delivery unit 112 links the ID of the selected advertisement information (permitted shop information) and the content (content ID) to each other and stores the information in the storage unit 130. In this way, the creator 83 makes a selection on “advertisement information from what type of shop is permitted to be linked and advertisement information from what type of shop is permitted to be delivered” so that advertisements that are not intended by the creator 83 are prevented from being delivered and linked to the content.

In a case where the creator 83 selects the content citation registration, the content is not directly uploaded from the creator terminal 40 to the server 10. That is, in the case where the creator 83 selects the content citation registration, the creator 83 inputs his/her registration ID for a music copyright registration DB (database) such as JASRAC (Japanese Society for Rights of Authors, Composers and Publishers) or TuneCore (copyright, etc. management business company), or his/her already registered content ID for, for example, Spotify (music delivery service company), and the creator terminal 40 links and registers the content and advertisement information.

More specifically, after the creator 83 has selected the content citation registration, the creator terminal 40 displays service (the above-mentioned JASRAC, Spotify, and the like) choices. Then, for example, in a case where the creator 83 selects Spotify, the creator terminal 40 displays a creator login screen for Spotify (a screen for linking the Spotify ID and the login ID for the registration application to each other).

When the creator 83 inputs the login ID and password for Spotify, the registration application ID and the Spotify ID are linked to each other, and the registration application is allowed to acquire a list of music content being delivered by Spotify. That is, the registration application communicates with the Spotify server via an API (Application Programming Interface) prepared on the Spotify server, to thereby acquire the list of music content. After the list of music content has been acquired by the creator terminal 40, permitted shops are checked as in the content upload registration.

In a case where the creator 83 selects the agency batch registration, the creator terminal 40 acquires lists of music content registered from music agencies in advance. After the lists of music content have been acquired by the creator terminal 40, permitted shops are checked as in the content upload registration.

### <Shop Step>

The shop clerk installs the advertisement setting application on the shop terminal 20. When launching the advertisement setting application for the first time, the clerk inputs the shop name, registered name (shop owner company name), address, bank account (or credit card number), shop type (similar to the shop types illustrated in the list G1 of FIG. 5), shop size (one of 1 to 20, 20 to 40, 40 to 100, 100 to 300, and 300 or more is selected as the maximum capacity), login ID, password, email address, and phone number to the advertisement setting application, to thereby register the shop. When the clerk registers the shop, the registration information is transmitted from the shop terminal 20 to the server 10. On the server 10, a shop ID is given to the registration information, and the shop ID and the registration information are linked and stored in the storage unit 130.

After the shop has been registered, when the clerk logs in with the login ID, three types of buttons: an advertisement setting button, a delivery setting button, a charging setting button, and a setting button are displayed by the shop terminal 20. When the clerk taps the setting button, there is displayed a setting screen where the registration information set when the advertisement setting application has been launched for the first time can be edited. When the clerk taps the advertisement setting button, a screen for creating an advertisement to be delivered together with content is displayed by the shop terminal 20.

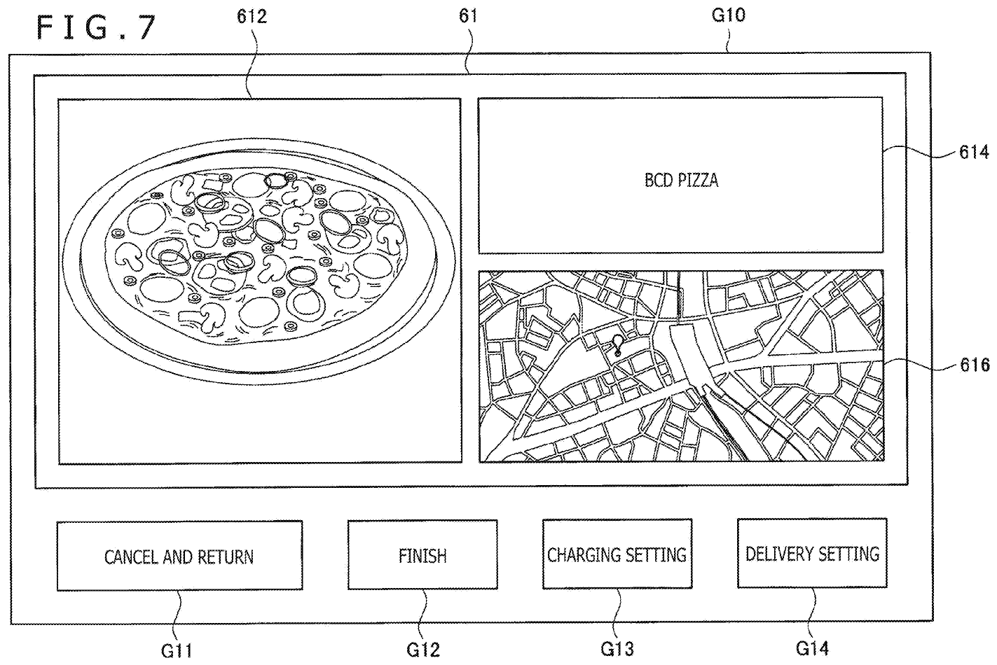

FIG. 7 is a diagram illustrating an exemplary advertisement creation screen. On an advertisement creation screen G10, an image frame 612, a shop name frame 614, and a shop location map frame 616 (for example, a map display frame by a Google map API) are displayed. When the clerk uploads an image that the clerk wants to deliver in an advertisement, the uploaded image is displayed in the image frame 612. In the shop name frame 614, the shop name set when the advertisement setting application has been launched for the first time is initially set. However, this shop name can also be edited.

In the shop location map frame 616, the map corresponding to the address input when the advertisement setting application has been launched for the first time is initially set. However, this map can also be edited. Note that, with only the address input by the clerk, the map icon is displayed at the center of the shop on the map. Thus, the map icon can preferably be moved by the operation of the clerk so that the map icon can be displayed near the shop entrance. Alternatively, in a case where the shop entrance is difficult to find, the shop entrance image can preferably be displayed on the map in a superimposed manner separately from the map icon.

When the clerk sets the image in the image frame 612, sets the shop name in the shop name frame 614, sets the map in the shop location map frame 616, and then taps a finish button G12, an advertisement 61 is created by the shop terminal 20 on the basis of the set information. The advertisement 61 is transmitted from the advertisement setting application to the server 10 as advertisement information. When receiving the advertisement information from the advertisement setting application, the server 10 links the received advertisement information and the ID of the shop (shop ID), which has transmitted the advertisement information, to each other and stores the information in the storage unit 130.

When the clerk taps a charging setting button G13, a charging setting screen is displayed by the shop terminal 20. On the charging setting screen, two types of charging setting are displayed: “subscription (30,000 yen per month)” and “shop visit possibility index-based charging.” In a case where the clerk selects “shop visit possibility index-based charging,” the shop terminal 20 further displays shop visit possibility index-based charging setting options, such as “shop visit possibility index 1000 (5,000 yen),” “shop visit possibility index 2000 (10,000 yen),” and “shop visit possibility index 3000 (20,000 yen).” When the clerk taps the finish button G12, the charging setting selected by the clerk is transmitted from the advertisement setting application to the server 10 as charging information, and the server 10 stores the charging information in the storage unit 130. Note that, the shop visit possibility index is described later.

When the clerk taps a delivery setting button G14, a delivery setting screen is displayed by the shop terminal 20. In a case where the advertisement setting and the charging setting are not complete, the shop terminal 20 displays a message prompting the completion of the advertisement setting and the charging setting.

On the delivery setting screen, the clerk selects content with which the advertisement is delivered. The content that can be selected by the clerk is transmitted from the server 10 to the shop terminal 20. At this time, permitted shop information (shop type selected by the creator) is associated with each piece of content. Thus, the delivery unit 112 preferably narrows down the content to which the advertisement information can be linked on the basis of the permitted shop information and the shop type of the shop terminal 20. Then, the delivery unit 112 preferably transmits the narrowed-down content to the shop terminal 20. With this, the content can be prevented from being delivered to the shop terminal 20 not intended by the creator 83.

More specifically, the delivery unit 112 collates the shop type of the shop terminal 20 with the permitted shop information associated with each piece of content. Then, the delivery unit 112 does not transmit content whose permitted shop information does not match the shop type to the shop terminal 20 (as unselectable content). Meanwhile, the delivery unit 112 transmits content whose permitted shop information matches the shop type to the shop terminal 20 (as selectable content).

The content received by the shop terminal 20 is displayed by the shop terminal 20. When the clerk selects content to be delivered with the advertisement, selection information including the ID of the selected content (content ID) and the ID of the shop terminal 20 (shop ID) is generated and transmitted to the server 10. Note that, the number of pieces of content that can be selected at the shop may be changed depending on how much the shop has paid (charged). With this, a plurality of pieces of music content of an album or a plurality of volumes of comic content can be simultaneously delivered to increase the ability to attract customers to the shop.

### <Server Step>

In the server 10, when the communication unit 140 receives selection information (content ID and shop ID) from the shop terminal 20, the selection information is stored in the storage unit 130. Then, the delivery unit 112 determines whether or not the content can be delivered on the basis of the selection information and the charging information (whether or not the amount of money required for the delivery of the selected content is equal to or less than the charging amount for the shop). In a case where the delivery unit 112 determines that the content can be delivered, the delivery unit 112 reads the advertisement information corresponding to the shop ID and the content information corresponding to the content ID, to thereby generate delivery information in which the content and the advertisement information are linked to each other.

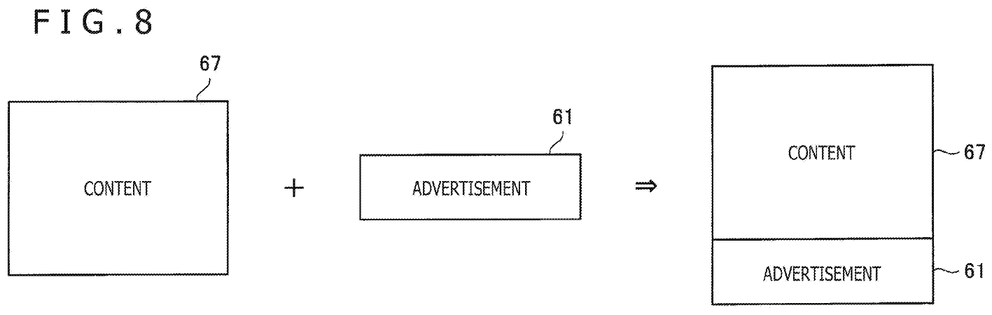

FIG. 8 is a diagram illustrating delivery information. As illustrated in FIG. 8, information in which content 67 and the advertisement 61 are linked to each other corresponds to the delivery information. After generating the delivery information, the delivery unit 112 updates the map information stored in the storage unit 130 of the server 10 (specifically, the information indicating where which content is being delivered on the map (the shop location linked to the shop ID)). For example, the delivery unit 112 arranges an icon at the shop location on the Google map using the Google map API on the basis of the delivery information.

### <User Step>

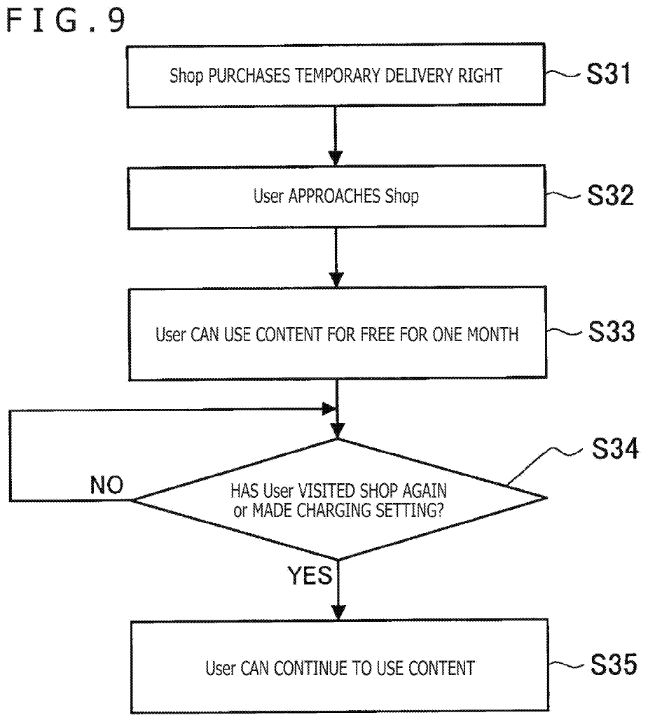

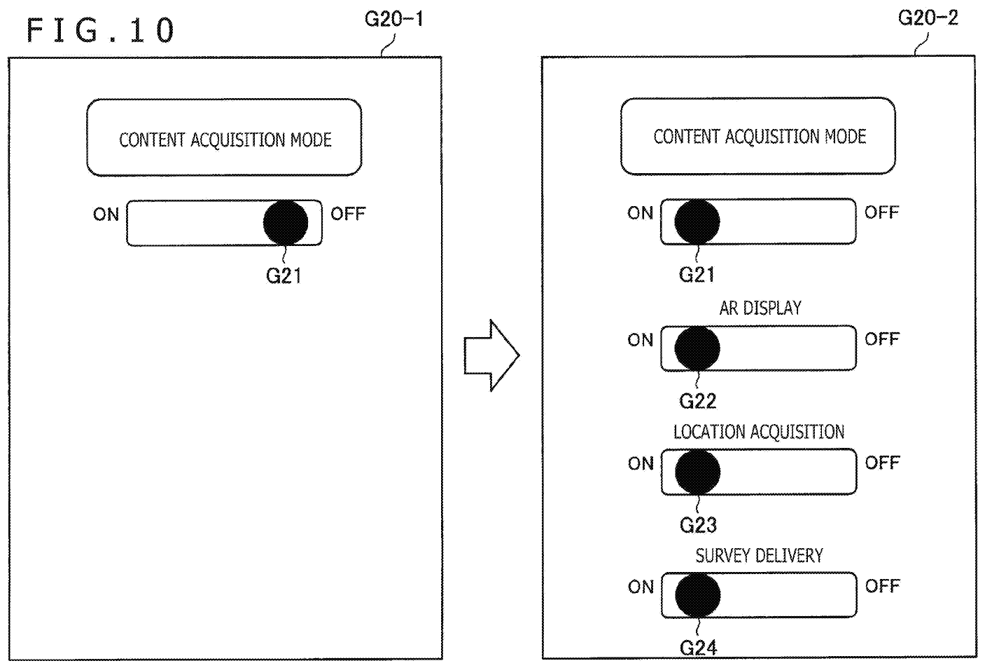

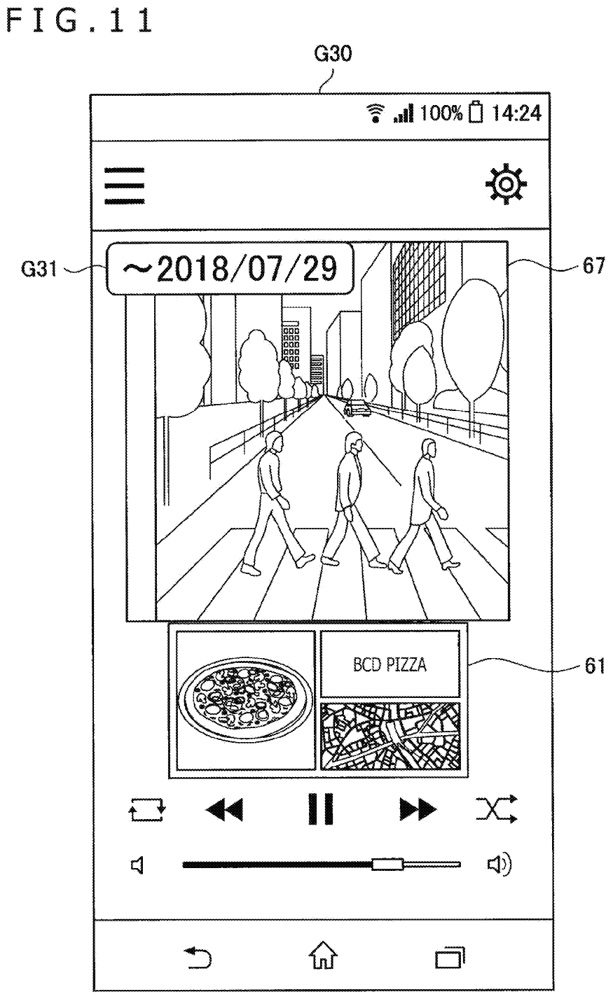

FIG. 9 is a diagram illustrating the flow of the user step. FIG. 10 is a diagram illustrating exemplary screens of the terminal application. FIG. 11 is a diagram illustrating exemplary display of the delivery information. The user 81 installs the terminal application on the user terminal 30. Then, when launching the terminal application for the first time, the user 81 sets the user ID, password, date of birth, attributes (office worker, student, or the like), and gender (male, female, or other) to the terminal application. When the user 81 logs in with the user ID, a content acquisition button, an acquired content display button, and a setting button are displayed.

When the user 81 taps the content acquisition button, a content acquisition mode ON/OFF changeover switch G21 is displayed as illustrated in a content acquisition mode selection screen G20-1. When the user 81 selects the content acquisition mode ON, the acquisition of location information regarding the user 81 is started. Meanwhile, when the content acquisition mode OFF is selected by the user 81, the location information regarding the user 81 is not acquired. With this, battery consumption due to location information acquisition can be reduced.

Further, in the case where the content acquisition mode ON is selected, the user terminal 30 may simultaneously display the detailed settings of the content acquisition mode. On a content acquisition mode selection screen G20-2, an AR (Augumented Reality) display ON/OFF changeover switch G22, a location acquisition ON/OFF changeover switch G23, and a survey delivery ON/OFF changeover switch G24 are displayed. With these switches, the detailed settings of the content acquisition mode can preferably be made. The AR display, the location acquisition, and the survey delivery are described later.

When the user 81 taps the acquired content display button, a list of content of which the user 81 has already acquired the usage rights is transmitted from the server 10 to the user terminal 30 to be displayed by the user terminal 30. The right to use content is described later. The user 81 can view content by selecting and reproducing the content. At this time, as illustrated in a delivery information display screen G30 of FIG. 11, the user terminal 30 preferably displays the advertisement 61 and an experienceable period G31 simultaneously in addition to the content 67. The experienceable period G31 is described below.

When the user 81 taps the experienceable period G31, the user terminal 30 displays an option of whether to extend the experienceable period by paying for the content. When the user 81 selects the payment for the content, the experienceable period is extended (may be set to an indefinite period).

When the user 81 taps the setting button, the user's registration information (the information set by the user when launching the terminal application for the first time) can be edited. Further, in a case where the user 81 makes charging setting, a credit card required for payment can be registered.

Now, there is described content acquisition in a case where the content acquisition mode ON/OFF changeover switch G21 is ON on the content acquisition mode selection screen G20-1. Under a state where the terminal application is being launched or a state where a location information application (an application configured to acquire user location information) linked to the terminal application is being launched, location information regarding the user (location information regarding the user terminal 30) is being transmitted to the server 10.

After the shop has purchased temporary delivery rights as described above (S31), in the server 10, the delivery unit 112 determines whether the user is near the shop (S32). That is, the delivery unit 112 determines whether or not the location information regarding the user and the location information regarding the shop described in the map information satisfy a predetermined condition (a condition that the user is within the 20 m radius around the shop). In a case where the delivery unit 112 determines that the user is near the shop, the delivery unit 112 gives the user the right to use the content registered and delivered by the shop.

Note that, to protect the user's personal information, the user terminal 30 may download the map information and determine whether or not the location information regarding the shop described in the map information and the location information regarding the user satisfy the predetermined condition inside the user terminal 30 without sending the location information regarding the user to the server 10. When the user acquires the right to use the content, the user terminal 30 displays the screen of a list of content, the usage rights of which have been acquired by the user. By selecting desired content from the content list screen, the user can stream or download the selected content.

In the server 10, the setting unit 113 generates, when the user streams or downloads the content for the first time, an experienceable period from the date and time of the transmission of the content. For example, the setting unit 113 sets, as the experienceable period, one month after the user has downloaded the content, and sets the experienceable period to the user application. The user can use (experience) the content for free for one month (S33). Further, the setting unit 113 stores information in which the experienceable period and the delivery information are linked to each other in the storage unit 130 as a delivery hash.

Note that, the content is preferably encrypted by DRM (Digital Rights Management) or the like. Further, there is preferably introduced a mechanism that allows the user terminal 30 to restore the content every time the user launches the terminal application during the experienceable period and causes the terminal application on the user terminal 30 to reject the restoration of the content after the expiration of the experienceable period. The setting unit 113 extends the experienceable period in a case where the location information regarding the user and the location information regarding the shop satisfy the predetermined condition again during the experienceable period.

Note that, as described above, the predetermined condition for setting the experienceable period (first-time condition) and the predetermined condition for extending the experienceable period (after-second-time condition) may be different from each other. For example, the first-time condition may be a condition that the user enters the 20 m radius around the shop, and the after-second-time condition may be a condition that the user enters a 30 m radius around the shop.

Further, in a case where the survey delivery is ON, a survey may be sent to the user terminal 30 when the predetermined condition described above is satisfied (specifically, the survey may be set to the shop terminal 20 in advance using the advertisement setting application to be stored in the server 10, and is only required to be transmitted from the server 10 to the user terminal 30 in a case where the predetermined condition is satisfied), and the setting unit 113 may extend the experienceable period in a case where the user answer the survey. With this, an effect that the shop can easily collect opinions from users as well as attracting customers to the shop can be expected.

Note that, the relationship (predetermined condition) between the registered location information regarding the advertisement providing shop and the location information regarding the user may be designed depending on the need. However, such a relationship is preferably dynamically designed from the location information regarding the advertisement providing shop and the size of the advertisement providing shop (shop size). For example, in regard to shops having the same shop location information, a predetermined distance of a 50 m radius is preferably set to the shop whose size is estimated to be large, and a predetermined distance of a 20 m radius is preferably set to the shop whose size is estimated to be small. These distances may be calculated from a table stored in advance in the storage unit 130 of the server 10. With this, shop size-reflected design is achieved.

Note that, a 20 m radius or more is preferably set. This is because the error of location information (an approximately 20 m radius in a case where GPS (Global Positioning System) is used) is reflected and the user can acquire content without entering the shop. When the system is designed so that the user cannot acquire content without entering the shop, there is a risk that the system is used by malicious shops (for example, shops that try to attract minors even though the type of shops is obviously not for minors). However, when the user can acquire content without entering the shop, an effect that the registration of such malicious shops is prevented is expected.

Further, the predetermined condition may include not only distance-related conditions but also time-related conditions. For example, the predetermined condition may include a time constraint such as that the user stays within the 20 m radius of the shop for a predetermined time or longer (for example, 10 seconds or longer). With this, the possibility that the user stays around the shop for the predetermined time or longer increases so that an effect that the shop can appeal to the user for a longer time can be expected.

Further, the setting unit 113 may change the predetermined condition depending on the charging amount for the shop. For example, the setting unit 113 may change the predetermined distance depending on the charging amount for the advertisement providing shop. For example, the setting unit 113 may set a predetermined distance of a 20 m radius for a shop whose charging amount is higher than a threshold and may set a predetermined distance of a 40 m radius for a shop whose charging amount is lower than the threshold. Further, the setting unit 113 may set, in regard to shops whose charging amounts are the same, a constraint that allows the shop with the predetermined distance of the 40 m radius to deliver two pieces of content and allows the shop with the predetermined distance of the 20 m radius to deliver only one content. With these, the degree of freedom in designing the appeal of attracting customers to the shop is enhanced.

Further, the experienceable period set by the setting unit 113 may be changeable for each piece of content.

Subsequently, the setting unit 113 determines whether the user has visited the shop again or not (has approached the shop again or not), or whether the user has made charging setting (setting for paying for the extension of the experienceable period) or not (S34). In a case where the user has neither visited the shop again nor made charging setting (“NO” in S34), the setting unit 113 returns to S34. Meanwhile, in a case where the user has visited the shop again or made charging setting (“YES” in S34), the setting unit 113 extends the content experienceable period. With this, the user can continue to use the content (S35).

### [1.4. Content]

Further, the advertisement delivery system may have a recommendation function of content to be delivered by the shop. For example, the shop terminal 20 displays options about “what type of customer is the attraction target” and recommends content to the clerk depending on which option has been selected by the clerk. For example, the shop terminal 20 displays a question such as “which customer group do you want to attract?” on the screen and also displays age group options (10s, 20s, 30 s . . . ). Then, when the teenager is selected by the clerk, the shop terminal 20 refers to ranking data stored in the server 10 in advance and recommends content popular with the teenager to the clerk (displays information regarding the content). With this, there is provided an effect that, even in a case where the shop side does not grasp content wanted by the group of customers whom the shop wants to attract, the shop can deliver content suitable for the group of customers whom the shop wants to attract, and can thus deliver content having a higher ability to attract customers.

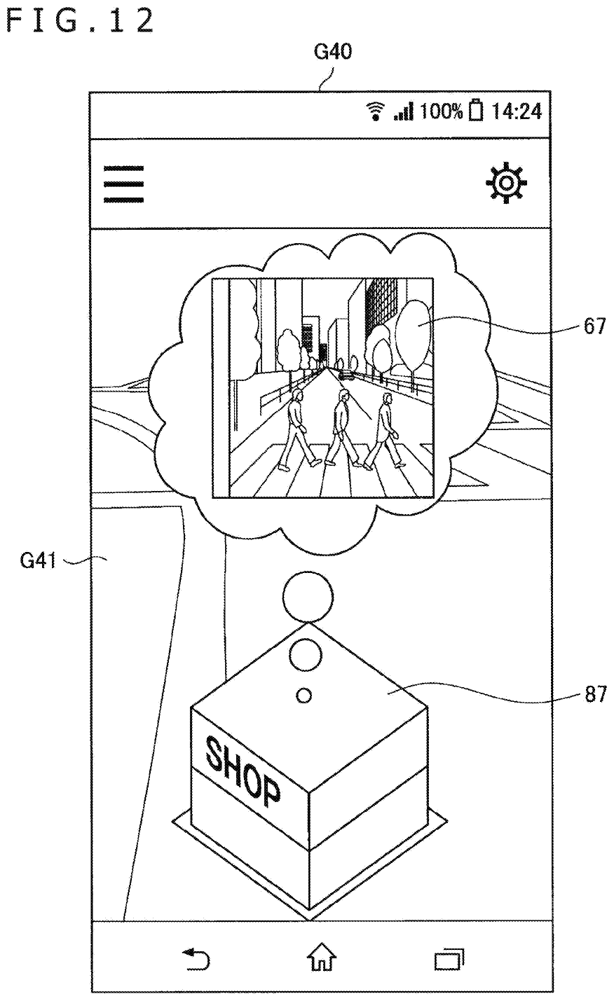

Further, the advertisement delivery shop and the delivery content are preferably displayed on the map in a superimposed manner on the user terminal 30. FIG. 12 is a diagram illustrating exemplary display of the advertisement delivery shop and the delivery content. With reference to FIG. 12, a delivery content display screen G40 is displayed by the user terminal 30. For example, in a case where the AR display is ON, a map G41 based on the location of the user is displayed on the delivery content display screen G40. Further, at the location corresponding to the shop 87 on the map G41, the content 67 that is delivered to the user when he/she approaches the shop 87 is displayed. With this function, the user can easily refer to information regarding the advertisement delivery shop and the delivery content on the map so that an effect that the user can more easily select which shop to approach can be expected.

Further, the advertisement setting application (the application for the shop terminal 20) may recommend, in a case where there is a shop in the neighborhood (for example, within a 100 m radius of the shop) that has set advertisement delivery by a similar application, delivery content on the basis of the content used by the nearby shop. For example, the shop terminal 20 preferably recommends, in a case where a nearby shop has set the delivery of a popular song among people in their 20s, a popular song among people in the same generation. Alternatively, the shop terminal 20 preferably recommends, in a case where a nearby shop has set the delivery of one of the songs from an album, a song from the same album.

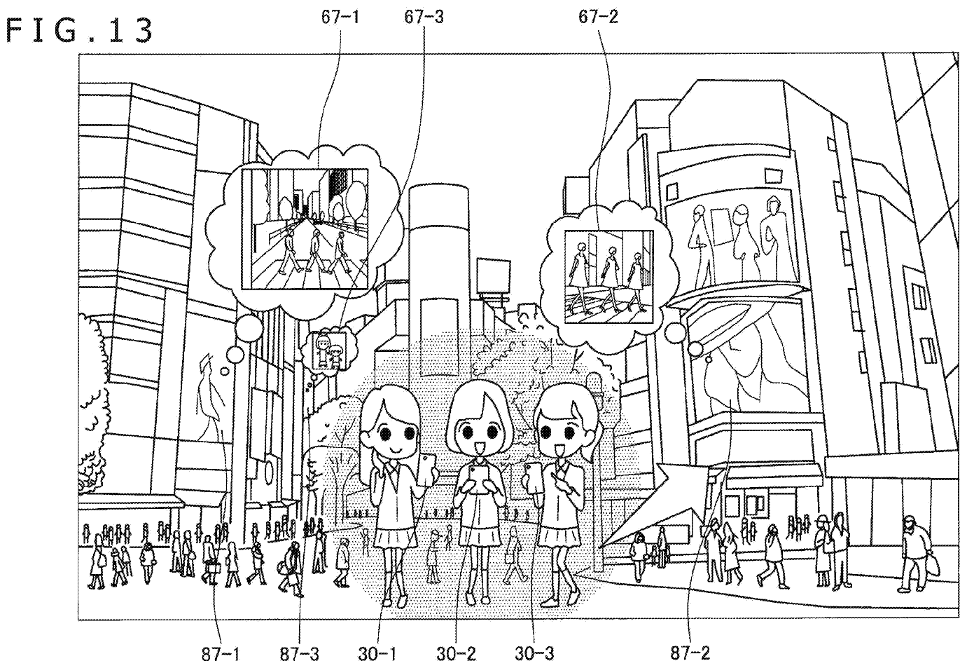

FIG. 13 is a diagram illustrating content examples that are recommended to the respective shop terminals 20. With reference to FIG. 13, a shop 87-1, a shop 87-2, and a shop 87-3 are neighbors. Thus, content 67-1 that is recommended to the shop terminal 20 of the shop 87-1, content 67-2 that is recommended to the shop terminal 20 of the shop 87-2, and content 67-3 that is recommended to the shop terminal 20 of the shop 87-3 are desirably related to each other (for example, are desirably similar to each other). Then, the users of the user terminals 30 (for example, user terminals 30-1 to 30-3) try harder to collect the content so that the ability to attract customers to the shops can increase.

Further, the shop terminal 20 may not recommend the same content as content already set to be delivered at a nearby shop. Alternatively, in a case where the clerk selects the same content as content already set to be delivered at a nearby shop, the shop terminal 20 preferably displays a confirmation screen: “the selected content has been delivered by the nearby shop, and are you sure you want to deliver it?” With such a recommendation function, an effect that the shop can deliver advertisements more effectively to attract customers can be expected.

### [1.5. Share Function]

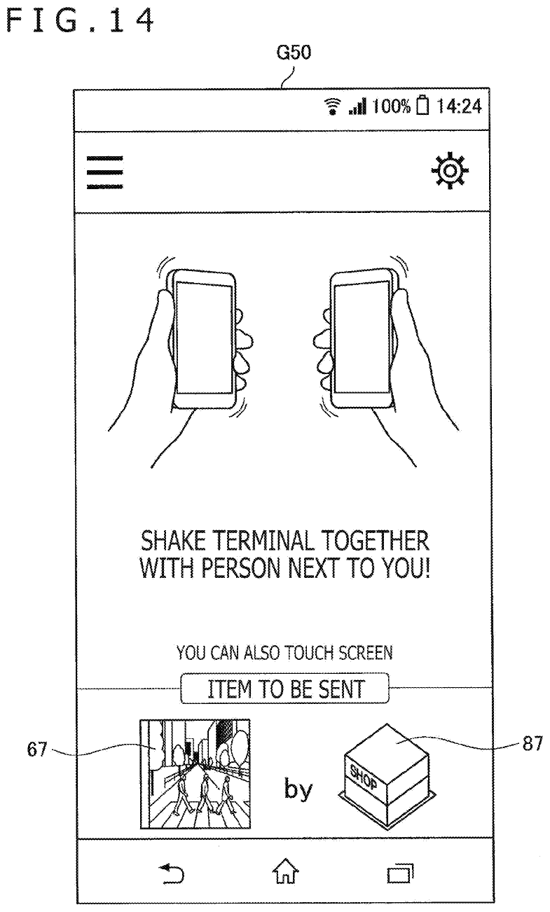

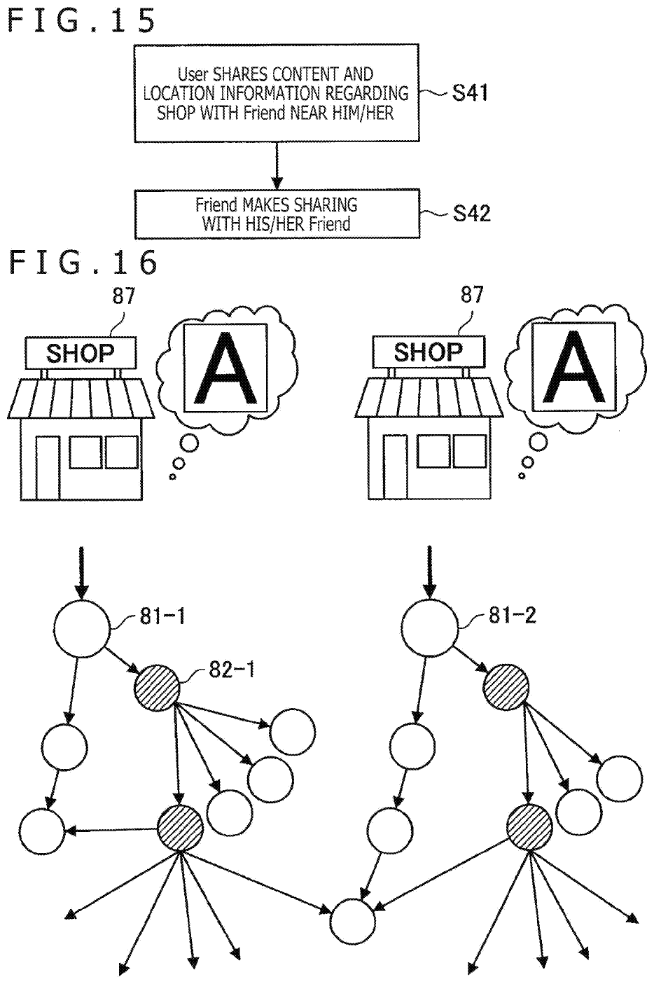

FIG. 14 is a diagram illustrating an exemplary share start screen. FIG. 15 is a diagram illustrating the flow of a share function. The user can share, in a case where the user has obtained the right to use content, the right to use the content with friends. Here, usage rights are not ownership, and hence the user cannot own the content even after purchasing the content. Thus, the content experienceable period can be set. At this time, as the experienceable period of the content shared with the friends and an advertisement linked to the content, the experienceable period and advertisement delivered to the user are set. With this, there can be provided an effect that the user and the friends are prevented from repeatedly sharing the content to substantially extend the experienceable period. Further, this also increases the possibility that the friends see the advertisement and visits the shop to extend the experienceable period.

That is, the delivery unit 112 can enable, on the basis of location information regarding a certain user (first user) and location information regarding a friend of the user (second user), sharing of a predetermined content with advertisement information with the friend. More specifically, the delivery unit 112 enables sharing of the predetermined content with the advertisement information with the friend in a case where the location information regarding the certain user and the location information regarding the friend of the user satisfy a predetermined condition (for example, a distance between the two is equal to or less than a certain distance). Moreover, the setting unit 113 sets, on the basis of the location information regarding the user and the location information regarding the friend of the user, the same period as the current experienceable period for the user as the experienceable period for the friend.

Further, the setting unit 113 may update the experienceable period for the user (share source) in a case where the experienceable period for the friend (share destination) is updated. Further, the setting unit 113 may update the experienceable period for the user (share source) in a case where the content is shared with the user (share source) after the content experienceable period for the friend (share destination) has been updated. Further, other than the content, the advertisement information, and the experienceable period, the location information regarding the shop is shared from the user to the friend (S41). Then, sharing from the friend to his/her friends may be made in a manner similar to sharing from the user to his/her friends (S42).

As illustrated in FIG. 14, the user terminal 30 of the user who wants to share the content may display a share start screen G50. As illustrated in the share start screen G50, the delivery unit 112 may share, in a case where it is detected that the user (share source) and the friend of the user (share destination) have shaken their respective user terminals 30, the content between the shaken two user terminals 30. Alternatively, the delivery unit 112 may share, in a case where it is detected that the user (share source) and the friend of the user (share destination) have touched the screens of the respective user terminals 30, the content between the two user terminals 30 whose screens have been touched.

Here, the friend is a person satisfying one of the following: (1) a person who has installed the terminal application and has made a friend registration (contact registration) with the user (the person who has installed the terminal application), (2) a person who has installed the terminal application and is near the user (for example, within a 10 m radius around the user), and (3) a person to whom the user can transmit URLs (Uniform Resource Locators) via an SNS (Social Networking Service) application such as LINE.

Note that, in the case of (1), to allow the user to make a friend registration with the friend, the friend needs to be within the predetermined distance (10 m radius) around the user. For example, when the user starts the friend registration mode of the terminal application, the terminal application acquires location information regarding the user and the friend and a friend request, and transmits the location information and the friend request to the server 10. When the server 10 determines that the location information regarding the user and the friend satisfies a predetermined condition, the server 10 registers the user IDs included in the friend request as friends.

In the case of (3), in a case where, while the terminal application is being launched, the user selects content in the content list display mode and taps a button for sharing the content, the terminal application acquires location information regarding the user and sends a share request, the location information regarding the user, and a delivery hash to the server 10. The delivery unit 112 generates, from the location information regarding the user, the share request, and the delivery hash, a URL that makes it possible to share the predetermined content. Then, the delivery unit 112 transmits the URL from the user to the friend (to be exact, from the user terminal 30 to the friend's terminal) via an SNS application such as LINE.

Then, a browser opens when the friend clicks the URL so that the friend can download the content on his/her terminal via the user terminal 30. At this time, the delivery unit 112 of the server 10 acquires location information regarding the friend when the browser opens. Then, the delivery unit 112 determines whether or not the location information regarding the friend and the location information regarding the user satisfy a predetermined condition. The delivery unit 112 preferably enables the download of the content in a case where the predetermined condition is satisfied. For example, the predetermined condition may be that the user is within a predetermined distance (for example, whether the user is within a 10 m radius with respect to the shop).

### [1.6. Application to Spotify]

Subscription music services such as Spotify (for example, the free plan is a streaming-only plan, and the paid plan is a streaming and download plan) may be applied to the embodiment of the present disclosure. For example, the application may encourage, in a case where the user who is using the free plan wants to download a delivery song that cannot be downloaded originally or extend the experienceable period on Spotify by approaching the shop as described above, the user to use the paid plan.

With this, the number of ways for encouraging the user to use the paid plan can increase by one. Further, in this case, the application may be configured so that, when the user shares content with a friend (the friend also uses the free plan on Spotify like the user) as described above, the friend can also download the song on Spotify.

### [1.7. Popularity Analysis]

Further, the analysis unit 114 visualizes a content sharing process. That is, the analysis unit 114 performs a predetermined analysis on the basis of the share status of predetermined content between users. FIG. 16 is a diagram illustrating an exemplary content sharing process. With reference to FIG. 16, users 81-1 and 81-2 who have actually approached the shop 87 and can thus experience content are illustrated. Further, the process of how the content has been shared from each of the user 81-1 and the user 81-2 is indicated by the arrows. For example, a friend 82-1 is a person with whom the user 81-1 has shared the content.

For example, the analysis unit 114 performs a trend analysis function by analyzing the share process, such as the number of content sharing that leads to a trend or a relationship between the type of share content and the type of users that leads to a trend. Specifically, the analysis unit 114 may determine, on the basis of when content has been shared between users, whether the share frequency in a predetermined popular period is higher than a threshold. Alternatively, the analysis unit 114 may identify, on the basis of users who have shared content, users who have shared the content with friends more frequently than a threshold (what is called an influencer (trend distributor)).

Further, the analysis unit 114 may register the user ID of an influencer (trend distributor) as an influencer ID and give some privilege to the user corresponding to the user ID registered as the influencer ID (for example, the experienceable period that is normally set to two weeks is set to four weeks for the influencer).

Alternatively, the analysis unit 114 may identify, on the basis of information regarding locations where predetermined content has been shared between users, an area where the frequency of sharing the content with friends is higher than a threshold. Information regarding an area where content is likely to be shared can be useful for discovering newcomer local artists (an artist A in the example illustrated in FIG. 16). Further, the analysis unit 114 may perform, in analysis, trend analysis on the basis of a share speed (a speed at which a user who has approached a predetermined shop and received delivered content repeatedly shares content so that the number of content shared locations increases).

### [1.8. Charging System]

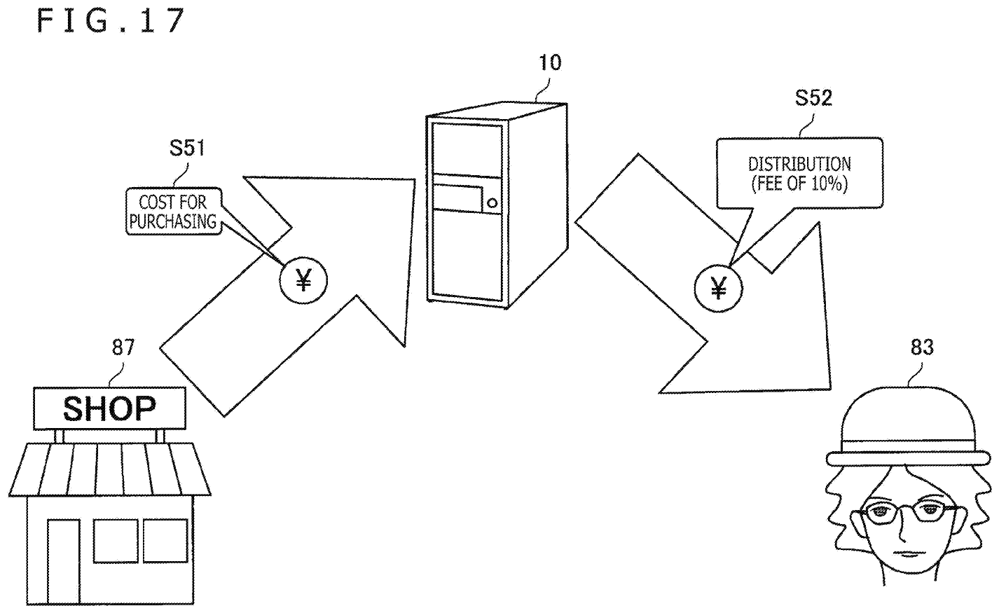

FIG. 17 is a diagram illustrating an exemplary charging system. Here, the content delivery and the number of times the content is shared greatly contribute to the possibility that the user (including friends) visits the shop. Thus, a charging model based on the possibility that the user visits the shop is preferred. That is, the setting unit 113 preferably sets the charging amount for the shop on the basis of an index indicating the possibility that one or a plurality of users who can experience predetermined content visits the shop (hereinafter also referred to as “shop visit possibility index”).

The shop visit possibility index may be calculated on the basis of at least one of the following: (1) the number of users who have obtained the right to use content on the basis of the positional relationship with the shop (the number of users who have actually approached the shop to obtain the right to use the content), (2) the number of users who have received the shared content based on the positional relationship with others (the number of friends who have received the shared content from others), (3) the number of users who can experience the predetermined content (that is, the total number of (1) and (2)), and (4) information regarding locations where the content has been shared between users.

For example, it is preferred that the setting unit 113 sets the value of a user who has actually approached the shop to obtain the right to use the content to “1,” the value of a friend who has received the shared content from the user to “0.5,” and the value of a friend who has received the shared content from the friend (what is called a friend of the friend) to “0.2,” and calculate, as the shop visit possibility index, a total value by adding values obtained by multiplying each value by the number of people. Further, the setting unit 113 may calculate the shop visit possibility index on the basis of share locations, for example, the setting unit 113 may set “1” when a share location is near the shop (for example, within a 2 km radius around the shop), and may set “0.2” when a share location is far from the shop (for example, outside the 2 km radius around the shop).

As illustrated in FIG. 17, the delivery unit 112 may calculate the amount of money based on the shop visit possibility index as the cost for the shop 87 to purchase the delivery rights (S51). Alternatively, the delivery unit 112 may calculate the amount of money based on a shop visit possibility index-based charging model as the cost for the shop 87 to purchase the delivery rights. Moreover, the delivery unit 112 calculates the usage fee of the content used for the advertisement delivery (a distribution amount to the creator 83) on the basis of the shop visit possibility index. Specifically, the delivery unit 112 is only required to calculate, as the distribution amount, the amount of money by subtracting fees from the billing amount (purchase cost) for the shop (S52).

### [1.9. Localized Delivery]

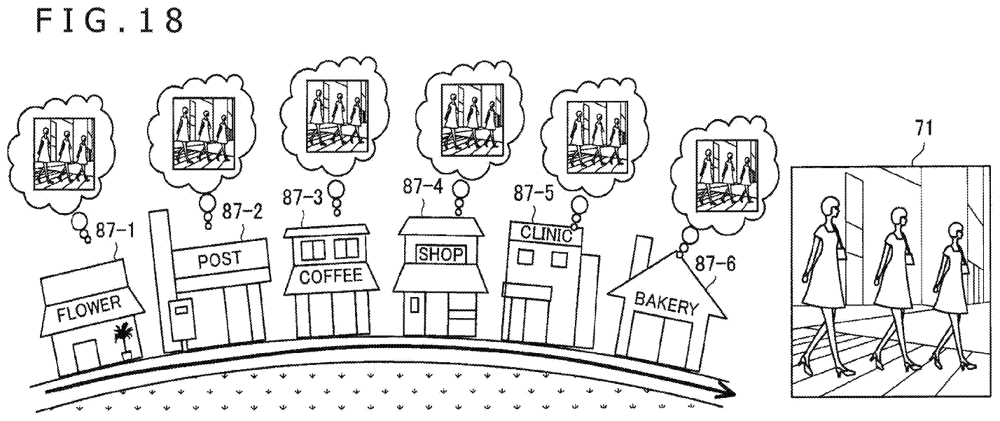

FIG. 18 is a diagram illustrating exemplary localized content delivery. As described above, as delivery content that is recommended to the shop terminal 20 of a certain shop, in a case where the shop and another shop have a predetermined relation (for example, the other shop is within the 2 km radius around the shop), content related to content that is delivered near the other shop may be recommended. Examples of relevant content include songs from the same album and different volumes of the same comic series. Then, in a case where the user obtains the right to use whole the relevant content, specific content may be delivered from the server 10 to the user terminal 30.

For example, with reference to FIG. 18, shops 87-1 to 87-6 exist within a predetermined distance (for example, within a 2 km radius), and pieces of content of which the user can obtain the usage rights by approaching the shops 87-1 to 87-6 are related to each other (for example, songs from the same album). Then, in a case where the user approaches the shops 87-1 to 87-6 to obtain the right to use all the songs from the same album (in a case where collecting the songs is complete), specific content 71 may be delivered from the server 10 to the user terminal 30. The specific content 71 may include the album cover or bonus video. Further, examples of relevant shops include shops belonging to the same affiliation (XX shopping district).

### [1.10. Review Interaction Function]

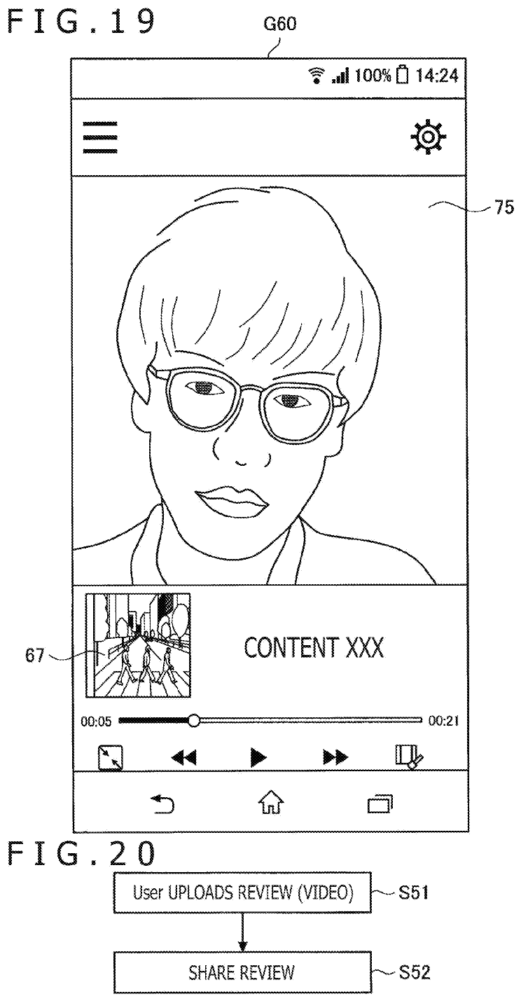

FIG. 19 is a diagram illustrating an exemplary content review input screen. FIG. 20 is a diagram illustrating the flow of review sharing. The advertisement delivery system 1 preferably has a function that allows the user or his/her friends who have obtained the right to use content to review the content. This function is preferably a function capable of capturing video 75 by the terminal application and recording the video 75, which is displayed simultaneously with the content 67, as a review as in a review input screen G60 illustrated in FIG. 19. At this time, the video captured by the terminal application is preferably recorded after being subjected to user face recognition and user face conversion (the replacement of the user's face with another face prepared in advance or the animation conversion of the user's face) using machine learning. With this, the user's personal information is protected.

The setting unit 113 associates the review (input data) input by the user who has experienced the content with the content, and makes it viewable to other users who satisfy a predetermined relationship with the user. Here, the predetermined relationship may include a predetermined positional relationship or a relationship registered in advance as having a relationship. More specifically, the review input by the user who has experienced the content is preferably viewable only by users closer to the user who has input the review (than a threshold) or users registered as friends of the user who has input the review. With this, the review can be shared locally to reduce the risk of flaming or the like.

At this time, the creator of the content may view the review of the content regardless of location information regarding the creator. That is, the setting unit 113 may associate a review (input data) input from the user who has experienced predetermined content with the predetermined content and make it viewable to the creator of the predetermined content (may allow the creator to view the content on the creator terminal 40).

Further, there may be provided a function that allows, when the user shares content with friends, the user to share the review with the friends together with the content. Specifically, the server 10 records the review and gives a review ID to the review, and the server 10 gives, when the user shares the content with the friends, the review ID to the content to be shared, to thereby allow the friends to download the review.

### [1.11. Analysis Function]

The analysis unit 115 analyzes information regarding by which content how many users have approached the shop or by what type of content what attributes of users have approached the shop, and provides the result to the shop terminal 20 and the creator terminal 40. Further, the analysis unit 115 analyzes information regarding what kind of content is delivered near what kind of shop and how the delivered content is experienced or shared, and provides the result to the shop terminal 20 and the creator terminal 40. At this time, answers for surveys as described above may be analyzed.

### [1.12. Share Point]

The server 10 may give share points to the user on the basis of the number of times the user has shared content with friends, the number of times the user has uploaded content reviews, or the number of times the user has answered surveys. Then, the server 10 may allow the user to use a predetermined service by the creator (to purchase limited goods or the like) on the basis of the share points given to the user.

### <2. Hardware Configuration Example>

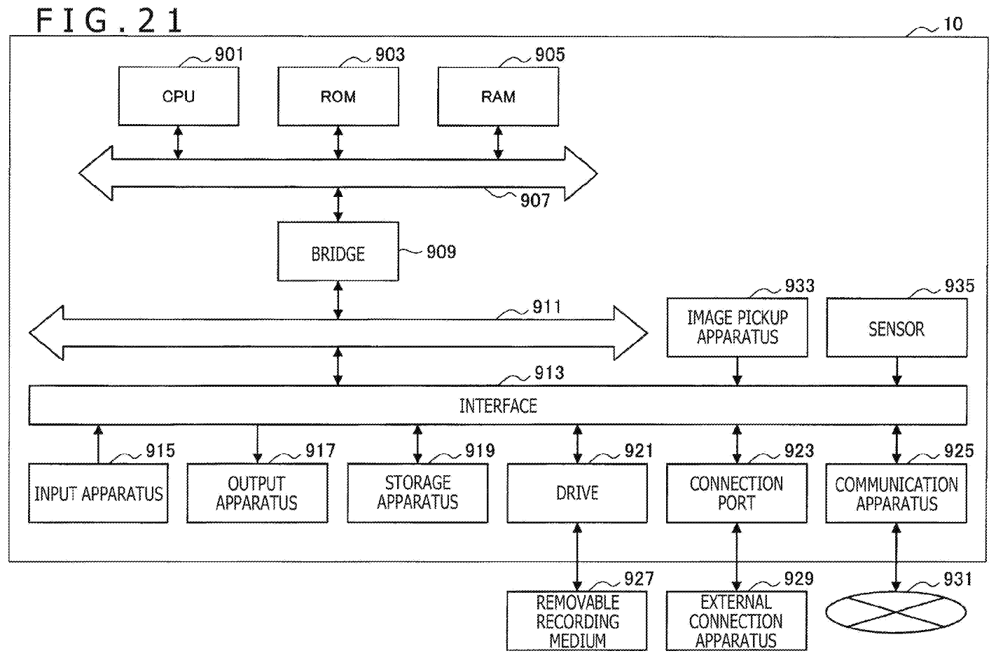

Next, with reference to FIG. 21, a hardware configuration example of the server 10 according to the embodiment of the present disclosure is described. FIG. 21 is a block diagram illustrating the hardware configuration example of the server 10 according to the embodiment of the present disclosure. Note that the server 10 does not necessarily include all the hardware components illustrated in FIG. 21 and may not include some of the hardware components illustrated in FIG. 21. Further, the hardware configuration of each of the shop terminal 20, the user terminal 30, and the creator terminal 40 may be achieved similarly to the hardware configuration of the server 10.

As illustrated in FIG. 21, the server 10 includes a CPU (Central Processing unit) 901, a ROM (Read Only Memory) 903, and a RAM (Random Access Memory) 905. Further, the server 10 may include a host bus 907, a bridge 909, an external bus 911, an interface 913, an input apparatus 915, an output apparatus 917, a storage apparatus 919, a drive 921, a connection port 923, and a communication apparatus 925. Moreover, the server 10 may include an image pickup apparatus 933 and a sensor 935 if necessary. The server 10 may include a processing circuit called DSP (Digital Signal Processor) or ASIC (Application Specific Integrated Circuit) in place of or in addition to the CPU 901.

The CPU 901 functions as an arithmetic processing apparatus and a control apparatus and controls the overall or part of the operation in the server 10 according to various programs recorded on the ROM 903, the RAM 905, the storage apparatus 919, or a removable recording medium 927. The ROM 903 stores programs, operation parameters, and the like that are used by the CPU 901. The RAM 905 temporarily stores programs that are used when the CPU 901 is executed and parameters that change as appropriate when the CPU 901 is executed. The CPU 901, the ROM 903, and the RAM 905 are connected to each other via the host bus 907 including an internal bus such as a CPU bus or the like. Moreover, the host bus 907 is connected to the external bus 911 such as a PCI (Peripheral Component Interconnect/Interface) bus via the bridge 909.

The input apparatus 915 is an apparatus that is operated by the user, such as a button. Examples of the input apparatus 915 may include mice, keyboards, touch panels, switches, and levers. Further, the input apparatus 915 may include a microphone configured to detect the user's voice. The input apparatus 915 may be a remote control apparatus that uses, for example, infrared radiation or another type of radio wave. Alternatively, the input apparatus 915 may be an external connection apparatus 929 such as a cell phone compatible to the operation of the server 10. The input apparatus 915 includes an input control circuit configured to generate input signals on the basis of information input by the user and output the generated input signals to the CPU 901. The user operates the input apparatus 915, thereby inputting various types of data or processing operation instructions to the server 10. Further, the image pickup apparatus 933, which is described later, may capture movement of a user's hand or a user's finger to function as an input apparatus. At this time, a pointing position may be determined according to the movement of the hand or a direction of the finger.

The output apparatus 917 includes an apparatus capable of notifying the user of acquired information visually or audibly. The output apparatus 917 may be, for example, a display apparatus such as an LCD (Liquid Crystal Display) or an organic EL (Electro-Luminescence) display, or an audio output apparatus such as a speaker or a headphone. Further, the output apparatus 917 may include a PDP (Plasma Display Panel), a projector, a hologram, a printer apparatus, or the like. The output apparatus 917 outputs the result of processing by the server 10 in the form of video including text, images, or the like, or sound such as voice or audio sound. Further, the output apparatus 917 may include lights for illuminating the surroundings, for example.

The storage apparatus 919 is a data storage apparatus configured as an example of the storage unit of the server 10. The storage apparatus 919 includes, for example, a magnetic storage device such as an HDD (Hard Disk Drive), a semiconductor storage device, an optical storage device, or a magneto-optical storage device. The storage apparatus 919 stores programs that are executed by the CPU 901, various data, various data acquired from the outside, and the like.

The drive 921 is a reader/writer for the removable recording medium 927 such as a magnetic disk, an optical disc, a magneto-optical disk, or a semiconductor memory, and is built in or externally attached to the server 10. The drive 921 reads information recorded on the mounted removable recording medium 927 and outputs the information to the RAM 905. Further, the drive 921 writes records on the mounted removable recording medium 927.

The connection port 923 is a port for directly connecting an apparatus to the server 10. The connection port 923 may be, for example, a USB (Universal Serial Bus) port, an IEEE 1394 port, or a SCSI (Small Computer System Interface) port. Further, the connection port 923 may be an RS-232C port, an optical audio terminal, an HDMI (registered trademark) (High-Definition Multimedia Interface) port, or the like. With the external connection apparatus 929 connected to the connection port 923, various data may be exchanged between the server 10 and the external connection apparatus 929.

The communication apparatus 925 is a communication interface including, for example, a communication device for connection to a network 931. The communication apparatus 925 may be, for example, a communication card for a wired or wireless LAN (Local Area Network), Bluetooth (registered trademark), or a WUSB (Wireless USB). Further, the communication apparatus 925 may also be, for example, a router for optical communication, a router for ADSL (Asymmetric Digital Subscriber Line), or a modem for various types of communication. For example, the communication apparatus 925 transmits/receives signals on the Internet or transmits/receives signals to/from another communication apparatus using a predetermined protocol such as TCP/IP. Further, the network 931 that is connected to the communication apparatus 925 is a network established through wired or wireless connection. The network 931 may be, for example, the Internet, a home LAN, infrared communication, radio wave communication, or satellite communication.

The image pickup apparatus 933 is an apparatus configured to capture a real space using an image pickup element such as a CCD (Charge Coupled Device) or a CMOS (Complementary Metal Oxide Semiconductor), and various members such as a lens for controlling object image formation onto the image pickup element, to thereby generate a captured image. The image pickup apparatus 933 may capture still images or video.

Examples of the sensor 935 include various sensors such as distance measuring sensors, accelerometers, gyro sensors, geomagnetic sensors, vibration sensors, optical sensors, and sound sensors. The sensor 935 acquires information regarding the state of the server 10 itself, such as a posture of the housing of the server 10, and information regarding a surrounding environment of the server 10, such as brightness and noise around the server 10. Further, the sensor 935 may include a GPS (Global Positioning System) sensor configured to receive GPS signals to measure latitude, longitude, and altitude of the apparatus.

### <3. Conclusion>

According to the embodiment of the present disclosure, there is provided the advertisement delivery system including an acquisition unit configured to acquire location information regarding a first user, an delivery unit configured to enable, on the basis of location information regarding an advertisement providing shop that has been registered and the location information regarding the first user, delivery of predetermined content with advertisement information from the advertisement providing shop, and a setting unit configured to set an experienceable period for the first user that indicates a period in which the first user is allowed to experience the predetermined content, in which the setting unit updates the experienceable period for the first user on the basis of the location information regarding the advertisement providing shop and the location information regarding the first user during the experienceable period for the first user.

With this configuration, it is possible to increase the number of users who purchase products or services sold by advertisement providers.

In the above, the preferred embodiment of the present disclosure has been described in detail with reference to the accompanying drawings, but the technical scope of the present disclosure is not limited to the example. It is obvious that various changes or modifications could be arrived at by persons who have ordinary knowledge in the technical field to which the present disclosure belongs within the scope of the technical ideas described in the appended claims, and it is therefore understood that such changes or modifications naturally belong to the technical scope of the present disclosure.

Further, the effects described herein are merely illustrative or exemplary and are not limited. That is, the technology according to the present disclosure may provide other effects that are obvious for persons skilled in the art from the description of the present specification, in addition to or in place of the above-mentioned effects.

Note that, the following configurations also belong to the technical scope of the present disclosure.
(1)

An advertisement delivery system including:

an acquisition unit configured to acquire location information regarding a first user;

a delivery unit configured to enable, on the basis of location information regarding an advertisement providing shop that has been registered and the location information regarding the first user, delivery of predetermined content with advertisement information from the advertisement providing shop; and

a setting unit configured to set an experienceable period for the first user that indicates a period in which the first user is allowed to experience the predetermined content,

in which the setting unit updates the experienceable period for the first user on the basis of the location information regarding the advertisement providing shop and the location information regarding the first user during the experienceable period for the first user.
(2)

The advertisement delivery system according to (1), in which the delivery unit enables the delivery of the predetermined content in a case where the location information regarding the advertisement providing shop and the location information regarding the first user satisfy a first condition.
(3)

The advertisement delivery system according to (1) or (2), in which the setting unit updates the experienceable period for the first user in a case where the location information regarding the advertisement providing shop and the location information regarding the first user satisfy a second condition during the experienceable period.
(4)

The advertisement delivery system according to (3), in which the second condition includes a condition that a distance between the advertisement providing shop and the first user is equal to or shorter than a predetermined distance.
(5)

The advertisement delivery system according to (4), in which the setting unit changes the predetermined distance depending on a charging amount for the advertisement providing shop.
(6)

The advertisement delivery system according to any one of (1) to (5), in which the setting unit updates the experienceable period for the first user in a case where the first user makes charging setting.
(7)

The advertisement delivery system according to any one of (1) to (6), in which the delivery unit enables, on the basis of the location information regarding the first user and location information regarding a second user, sharing of the predetermined content with the advertisement information with the second user.
(8)

The advertisement delivery system according to (7), in which the setting unit sets, on the basis of the location information regarding the first user and the location information regarding the second user, the same period as a current experienceable period for the first user as an experienceable period for the second user.
(9)

The advertisement delivery system according to any one of (1) to (8), in which the setting unit sets a charging amount for the advertisement providing shop on the basis of a shop visit possibility index indicating a possibility that one or a plurality of users who is allowed to experience the predetermined content visits the advertisement providing shop.
(10)

The advertisement delivery system according to (9), in which the shop visit possibility index is calculated on the basis of at least one of the number of users who have been allowed to experience the predetermined content, the number of users who have received the predetermined content delivered on the basis of a positional relationship with the advertisement providing shop, the number of users who have received the predetermined content shared on the basis of a positional relationship with another user, and information regarding a location where the predetermined content has been shared between users.

The advertisement delivery system according to any one of (1) to (10), in which the delivery unit narrows down content that is linkable to the advertisement information on the basis of a shop type selected by a creator of the predetermined content and a shop type of the advertisement providing shop.
(12)

The advertisement delivery system according to any one of (1) to (11), in which the setting unit associates input data from the first user who has experienced the predetermined content with the predetermined content and allows a third user who satisfies a predetermined relationship with the first user to view the input data.
(13)

The advertisement delivery system according to (12), in which the predetermined relationship includes a predetermined positional relationship or a relationship registered in advance as having a relationship.
(14)

The advertisement delivery system according to any one of (1) to (13), in which the setting unit associates input data from the first user who has experienced the predetermined content with the predetermined content and allows a creator of the predetermined content to view the input data.
(15)

The advertisement delivery system according to any one of (1) to (14), further including:

an analysis unit configured to perform predetermined analysis based on how the predetermined content has been shared between users.
(16)

The advertisement delivery system according to (15), in which the analysis unit performs the predetermined analysis by identifying, on the basis of the users who have shared the predetermined content, a user who has shared the predetermined content with another user more frequently than a first threshold.
(17)

The advertisement delivery system according to (15), in which the analysis unit performs the predetermined analysis by determining, on the basis of when the predetermined content has been shared between the users, whether a share frequency in a predetermined popular period is higher than a second threshold.
(18)

The advertisement delivery system according to (15), in which the analysis unit performs the predetermined analysis by identifying, on the basis of information regarding a location where the predetermined content has been shared between the users, an area where a frequency of sharing the predetermined content with another user is higher than a third threshold.
(19)

An information processing apparatus including:

an acquisition unit configured to acquire location information regarding a first user;

a delivery unit configured to enable, on the basis of location information regarding an advertisement providing shop that has been registered and the location information regarding the first user, delivery of predetermined content with advertisement information from the advertisement providing shop; and

a setting unit configured to set an experienceable period for the first user that indicates a period in which the first user is allowed to experience the predetermined content,

in which the setting unit updates the experienceable period for the first user on the basis of the location information regarding the advertisement providing shop and the location information regarding the first user during the experienceable period for the first user.
(20)

An information processing method including:

acquiring, by a processor, location information regarding a first user;

enabling, by the processor, on the basis of location information regarding an advertisement providing shop that has been registered and the location information regarding the first user, delivery of predetermined content with advertisement information from the advertisement providing shop;

setting, by the processor, an experienceable period for the first user that indicates a period in which the first user is allowed to experience the predetermined content; and

updating, by the processor, the experienceable period for the first user on the basis of the location information regarding the advertisement providing shop and the location information regarding the first user during the experienceable period for the first user.

### REFERENCE SIGNS LIST

1: Advertisement delivery system

10: Server

110: Control unit

111: Acquisition unit

112: Delivery unit

113: Setting unit

114: Analysis unit

115: Analysis unit

130: Storage unit

140: Communication unit

20: Shop terminal

30: User terminal

40: Creator terminal

50: Network

1. An advertisement delivery system comprising:
an acquisition unit configured to acquire location information regarding a first user;
a delivery unit configured to enable, on a basis of location information regarding an advertisement providing shop that has been registered and the location information regarding the first user, delivery of predetermined content with advertisement information from the advertisement providing shop; and
a setting unit configured to set an experienceable period for the first user that indicates a period in which the first user is allowed to experience the predetermined content,
wherein the setting unit updates the experienceable period for the first user on the basis of the location information regarding the advertisement providing shop and the location information regarding the first user during the experienceable period for the first user.

2. The advertisement delivery system according to claim 1, wherein the delivery unit enables the delivery of the predetermined content in a case where the location information regarding the advertisement providing shop and the location information regarding the first user satisfy a first condition.

3. The advertisement delivery system according to claim 1, wherein the setting unit updates the experienceable period for the first user in a case where the location information regarding the advertisement providing shop and the location information regarding the first user satisfy a second condition during the experienceable period.

4. The advertisement delivery system according to claim 3, wherein the second condition includes a condition that a distance between the advertisement providing shop and the first user is equal to or shorter than a predetermined distance.

5. The advertisement delivery system according to claim 4, wherein the setting unit changes the predetermined distance depending on a charging amount for the advertisement providing shop.

6. The advertisement delivery system according to claim 1, wherein the setting unit updates the experienceable period for the first user in a case where the first user makes charging setting.

7. The advertisement delivery system according to claim 1, wherein the delivery unit enables, on a basis of the location information regarding the first user and location information regarding a second user, sharing of the predetermined content with the advertisement information with the second user.

8. The advertisement delivery system according to claim 7, wherein the setting unit sets, on the basis of the location information regarding the first user and the location information regarding the second user, a same period as a current experienceable period for the first user as an experienceable period for the second user.

9. The advertisement delivery system according to claim 1, wherein the setting unit sets a charging amount for the advertisement providing shop on a basis of a shop visit possibility index indicating a possibility that one or a plurality of users who is allowed to experience the predetermined content visits the advertisement providing shop.

10. The advertisement delivery system according to claim 9, wherein the shop visit possibility index is calculated on a basis of at least one of the number of users who have been allowed to experience the predetermined content, the number of users who have received the predetermined content delivered on a basis of a positional relationship with the advertisement providing shop, the number of users who have received the predetermined content shared on a basis of a positional relationship with another user, and information regarding a location where the predetermined content has been shared between users.

11. The advertisement delivery system according to claim 1, wherein the delivery unit narrows down content that is linkable to the advertisement information on a basis of a shop type selected by a creator of the predetermined content and a shop type of the advertisement providing shop.

12. The advertisement delivery system according to claim 1, wherein the setting unit associates input data from the first user who has experienced the predetermined content with the predetermined content and allows a third user who satisfies a predetermined relationship with the first user to view the input data.

13. The advertisement delivery system according to claim 12, wherein the predetermined relationship includes a predetermined positional relationship or a relationship registered in advance as having a relationship.

14. The advertisement delivery system according to claim 1, wherein the setting unit associates input data from the first user who has experienced the predetermined content with the predetermined content and allows a creator of the predetermined content to view the input data.

15. The advertisement delivery system according to claim 1, further comprising:
an analysis unit configured to perform predetermined analysis based on how the predetermined content has been shared between users.

16. The advertisement delivery system according to claim 15, wherein the analysis unit performs the predetermined analysis by identifying, on a basis of the users who have shared the predetermined content, a user who has shared the predetermined content with another user more frequently than a first threshold.

17. The advertisement delivery system according to claim 15, wherein the analysis unit performs the predetermined analysis by determining, on a basis of when the predetermined content has been shared between the users, whether a share frequency in a predetermined popular period is higher than a second threshold.

18. The advertisement delivery system according to claim 15, wherein the analysis unit performs the predetermined analysis by identifying, on a basis of information regarding a location where the predetermined content has been shared between the users, an area where a frequency of sharing the predetermined content with another user is higher than a third threshold.

19. An information processing apparatus comprising:
an acquisition unit configured to acquire location information regarding a first user;
a delivery unit configured to enable, on a basis of location information regarding an advertisement providing shop that has been registered and the location information regarding the first user, delivery of predetermined content with advertisement information from the advertisement providing shop; and
a setting unit configured to set an experienceable period for the first user that indicates a period in which the first user is allowed to experience the predetermined content, wherein the setting unit updates the experienceable period for the first user on the basis of the location information regarding the advertisement providing shop and the location information regarding the first user during the experienceable period for the first user.

20. An information processing method comprising:
acquiring, by a processor, location information regarding a first user;
enabling, by the processor, on a basis of location information regarding an advertisement providing shop that has been registered and the location information regarding the first user, delivery of predetermined content with advertisement information from the advertisement providing shop;
setting, by the processor, an experienceable period for the first user that indicates a period in which the first user is allowed to experience the predetermined content; and
updating, by the processor, the experienceable period for the first user on the basis of the location information regarding the advertisement providing shop and the location information regarding the first user during the experienceable period for the first user.
